(19) United States
(12) Patent Application Publication
(10) Pub. No.: US 2025/0292331 A1
(43) Pub. Date: Sep. 18, 2025

(54) APPARATUS AND METHOD FOR IMPROVING CLAIM REMITTANCE USING DETECTED CLAIM DENIAL PATTERNS

(71) Applicant: RevOps Health, Inc., Wellesley, MA (US)

(72) Inventors: Wayzen Lin, Wellesley, MA (US); Dmitry Kit, Marietta, GA (US); Ben Isherwood, Tewksbury, MA (US)

(73) Assignee: RevOps Health, Inc., Wellesley, MA (US)

(21) Appl. No.: 19/065,944

(22) Filed: Feb. 27, 2025

Related U.S. Application Data
(60) Provisional application No. 63/565,925, filed on Mar. 15, 2024.
(60) Provisional application No. 63/715,291, filed on Nov. 1, 2024.

(51) Int. Cl. G06Q 40/08

(52) U.S. Cl. CPC G06Q 40/08

(57) ABSTRACT

An apparatus and method for processing records associated with adjudication decisions that include: obtaining records associated with respective adjudication decisions; proceeding, starting with factors in the obtained records and in an iterative or recursive manner, to: determine a number of factors for evaluating the obtained records, select the determined number factors from plural factors comprised in the obtained records, identify a subset of records described by the selected factors, record the identified subset of records in association with the selected factors as a factor set to a data storage, and remove the subset of records from the obtained records for a next iteration until the obtained plurality of records have been all removed; and outputting factor sets and associated subsets of records from the data storage for displaying factor sets and associated subsets of records in correspondence with one or more adjudication decisions comprised in the associated subsets of records.

### CROSS-REFERENCE TO RELATED PATENT APPLICATIONS

This application is based on and claims priority to U.S. Provisional Patent Application 63/565,925, filed Mar. 15, 2024 and U.S. Provisional Patent Application 63/715,291, filed Nov. 1, 2024, which are hereby incorporated by reference as if expressly set forth in their respective entireties herein.

### FIELD OF THE DISCLOSURE

The present disclosure generally relates to computer processing and, more specifically, to a computer-implemented method and system for improving claim remittance approval.

### BACKGROUND OF THE DISCLOSURE

Healthcare providers, such as doctors, therapists, nurses, or the like, perform medical procedures and/or provide medical services for patients, who often carry medical insurance to remunerate the healthcare providers for the medical services. In order to qualify for reimbursements, healthcare providers submit a claim to the insurer. Unfortunately, claims can require extensive details representing services and associated costs, as well as supporting evidence to demonstrate that the services were both necessary and appropriate.

Insurers adjudicate claims received from healthcare providers according to contractual rules. Such rules can be burdensome, such as to impose restrictions on the qualifications of a medical provider for specific services, or requiring for pre-authorization in advance of a service. Outcomes of an adjudication can be a) approved (full payment), b) adjusted (partial payment), or c) denied (zero payment). In many cases, insurers provide explanations for adjustments and denials, and providers can appeal unfavorable adjudications with corrected claims for resubmission. Unfortunately, claim adjustments and denials are a significant inconvenience for providers, often resulting in reduced payment or non-payment for services that had been already rendered. Such services then become resources lost without recompense.

As such, there is an ongoing need for improving claim submissions and/or re-submissions to reduce claim adjustments and denials. Medical billers who interact with insurers on providers' behalf are often required to manage thousands of claims per week. Further, changes in insurance documentation requirements for high-volume services often result in many denials due to nonconformance, often taking months to identify and rectify. In such cases, claims need to be refiled, resulting in substantial additional administrative work, cost, and delayed or lost revenue. Thus, it is prohibitively difficult to track large volumes of claim denials and adjustments,

It is with respect to these and other concerns that the present disclosure is made.

### SUMMARY OF THE DISCLOSURE

The present disclosure includes systems and methods for improving claim submission and re-submission, including by processing past information associated with claim adjustments and/or denials, identifying patterns and trends, and precluding adjustments and denials as a function of improved claims.

The present disclosure includes a computer-implemented method and system that can analyze large quantities of remittance documents and identify relevant patterns, such as reasons for insurance claim denials, and to provide improved subsequent claim submissions, which would avoid claim denials and/or adjustments. Actionable denials encompass a broad spectrum of errors, including but not limited to errors & omissions in a claim, lack of (or limited) coverage in a patient's insurance plan, procedures that are counter to a diagnosis, or providers who are not credentialled or qualified to perform the claimed services. In one or more implementations, one or more computing devices receive insurer remittance documents that are in the X12 835 ANSI-standardized format. Such remittance documents can be processed to correlate characteristic patterns with common adjudication outcomes. For example, one or more unique statistical processes can be employed by one or more computing devices to identify and correlate patterns with respective outcomes, which significantly reduces computing load in comparison to, for example, brute force processes. Accordingly, the present disclosure is applicable to a computer-implemented method and system that is capable of surveilling millions of records in various formats including, but not limited, to X12 835-encoded records, to correlate characteristic patterns with common adjudication outcomes and identify actionable denials.

Thus, the present disclosure provides a method and system for healthcare providers, medical billers, or the like, to identify and correct systemic issues associated with claim submissions and, furthermore, for any administrative service providers, such as medical billers, to quantify their scope and impact on a practice's revenue operations According to one or more example implementations, document processing is performed to track an expected value for one or more services rendered. For example, different permutations associated with a service can be tracked, such as relating to various providers, modifiers, payers, diagnoses, facilities, or the like), which can then be used to sum a more accurate potential loss figure associated with denials. Remittance can be calculated based on estimated potential losses from denials that are actionable and, therefore, recoverable from the processing. In certain embodiments, different permutations of parameters of the processed remittance documents, such as providers, modifiers, payers, diagnoses, facilities, to name a few, can be used to determine potential losses associated with actionable denials.

### BRIEF DESCRIPTION OF THE DRAWING FIGURES

Various example implementations of this disclosure will be described in detail, with reference to the following figures, wherein:

FIG. 1 is a flow diagram illustrating a remittance data evaluation process according to one or more example implementations of the present disclosure.

FIG. 2A is a graphical diagram illustrating an information display according to one or more example implementations of the present disclosure.

FIG. 2B is a graphical diagram illustrating another information display according to one or more example implementations of the present disclosure.

FIG. 3 is a graphical diagram illustrating yet another information display according to one or more example implementations of the present disclosure.

FIG. 4 is a flow diagram illustrating a remittance data evaluation process according to another one or more example implementations of the present disclosure.

FIG. 5 is a schematic diagram of an example hardware arrangement that operates for providing the systems and methods of the present disclosure.

FIG. 6 is a schematic diagram of an example information processor that can be used to implement the techniques of the present disclosure.

### DETAILED DESCRIPTION OF CERTAIN EMBODIMENTS OF THE DISCLOSURE

By way of overview and introduction, the present disclosure includes a computer-implemented method and system that includes processing large volumes of remittance document data and identifying patterns in adjudication decisions, as well as improving guidance on claims handling processes and protocols, thereby avoiding denials for new claims and re-submissions and improving likelihood of remittance. The present disclosure provides relevant information that is usable by healthcare providers to generate improved claim submissions and/or resubmissions for insurance reimbursements associated with rendered healthcare services. In one or more implementations of the present disclosure, large quantities of remittance documents are processed by one or more computing devices to identify relevant patterns associated with claim denials. Advantageously, the identified patterns corresponding to associated adjudication decisions, such as claim adjustments or claim denials, can be used to formulate one or more remittance document generation strategies adapted to address or avoid certain adjudication decisions.

In one or more particular implementations, the present disclosure provides technological solutions for processing large quantities of claims-related data and identifying adjudication outcome patterns, including in medical practices having to process volumes (e.g., thousands) of claims per week, efficiently and continuously. Unique statistical processes can be employed for analyzing remittance documents, which can substantially reduce loads and use of computing resources, thereby facilitating the processing of very large quantities of such documents without exorbitant computing power. Processes for analyzing high volumes of remittance documents can include maximizing an objective function f (x) for evaluating processed remittance documents that balances the size of a factor set. This can include, for example, factors (or characteristic parameters) of processed documents (or records) with the number of records (or documents) that the factor set describes.

Table 1, below, provides an example of six (6) remittance records (e.g., claims) that are each shown in a respective row with four (4) factors from four (4) corresponding categories that describe the respective records: Payer, Provider, Facility, and Procedure.

TABLE 1

| Payer | Provider | Facility | Procedure |
|---|---|---|---|
| PAYER 1 | PROVIDER 1 | FACILITY 2 | PROCEDURE 1 |
| PAYER 1 | PROVIDER 2 | FACILITY 1 | PROCEDURE 2 |
| PAYER 2 | PROVIDER 1 | FACILITY 1 | PROCEDURE 3 |
| PAYER 2 | PROVIDER 1 | FACILITY 1 | PROCEDURE 2 |
| PAYER 2 | PROVIDER 3 | FACILITY 1 | PROCEDURE 1 |
| PAYER 2 | PROVIDER 2 | FACILITY 3 | PROCEDURE 3 |

The “Payer” category denotes the payer or insurer (e.g., Payer 1 and Payer 2) of a patient that received the healthcare services associated with the record. The “Provider” category denotes the respective healthcare provider (e.g., Provider 1, Provider 2, and Provider 3). The “Facility” category denotes the facility (e.g., Facility 1, Facility 2, and Facility 3) where associated healthcare services were rendered. The “Procedure” category denotes the procedure (e.g., Procedure 1, Procedure 2, and Procedure 3) that was performed as part of the healthcare services received by the patient and associated with the record. Of course, one of ordinary skill in the art will recognize that the records in Table 1 are meant for illustrative purposes only and that the number of records and factors are not limited to the precise example shown.

Based on Table 1, patterns in the records can be identified, for example, by using different numbers of the factors in the records. Table 2, below, provides an example of eight (8) different factor patterns that can be identified based on the records of Table 1.

TABLE 2

| Pattern | | Matching |
|---|---|---|
| ID | Pattern | rows |
| 1 | Payer 1, Provider 1, Facility 2, Procedure 1 | 1 |
| 2 | Payer 1, Provider 2, Facility 1, Procedure 2 | 1 |
| 3 | Payer 2, Provider 1, Facility 1, Procedure 3 | 1 |
| 4 | Payer 2, Provider 1, Facility 1, Procedure 2 | 1 |
| 5 | Payer 2, Provider 3, Facility 1, Procedure 1 | 1 |
| 6 | Payer 2, Provider 2, Facility 3, Procedure 3 | 1 |
| 7 | Payer 1 | 2 |
| 8 | Payer 2 | 4 |

As shown in Table 2, patterns 1-6 each includes a pattern of all four (4) factors shown in Table 1. As such, each of patterns 1-6 matches one row (or record) in Table 1 because Table 1 does not include any records with the same four-factor pattern. Pattern 7 includes only one (1) factor, Payer, and matches two (2) rows in Table 1 because there are two records in Table 1 with a “Payer 1.” Correspondingly, pattern 8 matches the remaining four (4) rows in Table 2 as the ones with “Payer 2.”

As illustrated above, factor pattern rules for processing data records are more likely to describe fewer records (or items) as the factor pattern rule increases is because such longer factor pattern rules are more specific to individual records. For example, the four-factor patterns 1-6 in Table 2 are specific to a single record from Table 1 and each describes only one record. On the other hand, each of the short one-factor patterns 7-8 shown in Table 2 describes two and four records, respectively, and together represent a maxima of source data. It is to be recognized that rules based on these broad patterns may be insufficient to identify any meaningful patterns in the source data.

As such, rules that do not filter too many records compared to one factor rules, such as patterns 7-8, are sought. According to one or more example implementations of the present disclosure, an algorithm for finding patterns that maximize record factors and the number of records that match the record factors, in balance, can be executed. Advantageously, the present disclosure provides a unique algorithm with statistical processes for finding such patterns and thereby significantly reducing the processing required for analyzing these records by avoiding the need to process the patterns shown in Table 2.

Table 3, below, identifies three (3) factor patterns that yield more records than patterns 1-6 of Table 2 but are more specific (and yield fewer records) than patterns 7-8 of Table 2.

TABLE 3

| Pattern | | Matching |
|---|---|---|
| ID | Pattern | rows |
| 9 | Procedure 1 | 2 |
| 10 | Payer 2, Provider 1 | 2 |
| 11 | Payer 2, Procedure 3 | 2 |

As represented above in Table 3, patterns 9-10 have more relevance than the prior pattern set of Table 2. Each pattern applies to multiple rows of data that are sufficiently specific to discern a meaningful pattern. Pattern 9, for example, includes one factor. Procedure 1, which demonstrates that the factor length of a rule can depend on a characteristic of the underlying factor, for example, a generality, a specificity, a commonality, a rarity, or the like.

Accordingly, and based on this concept, one or more computing devices can execute instructions that operate to scale the factor analysis, such as for hundreds of parameters associated with millions of rows. Advantageously, the scaled factor analysis with a balanced factor length rule determination of the present disclosure keeps computational power at a fraction of the cost of known brute force discovery methods.

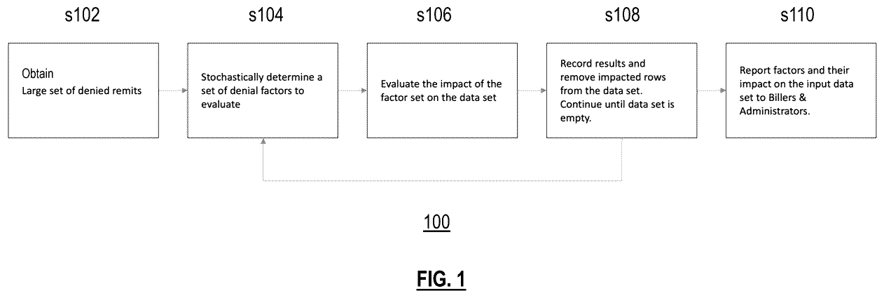

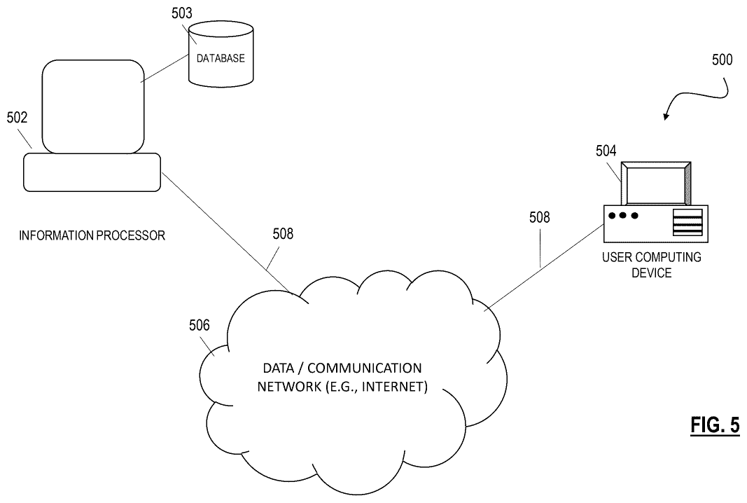

Referring now to the drawings, FIG. 1 is a flow diagram illustrating a process 100 according to an example implementation of the present disclosure. In one or more implementations of the present disclosure, process 100 can be executed at one or more computing devices 504 and/or 502 (FIG. 5).

As illustrated in FIG. 1, process 100 begins with step s102, where the computing device(s) 504 and/or 502 obtains a large set of data files containing remittance data. The computing device(s) 504 and/or 502 can obtain the remittance data from one or more storage databases 503 (FIG. 5) that can record and archive various information, including remittance data, for example, via network communications 506 and 508 (FIG. 5), such as through the Internet, or the like. In one or more example embodiments, remittance data can comprise 835-encoded records. Moreover, the one or more computing devices 504 and/or 502 can execute one or more processes to refine the remittance data, for example, to isolate denied and/or adjusted claims to uniformity in format, or the like, to form an evaluation set of the obtained remittance data. In other embodiments, the obtained remittance data can form the evaluation set. According to one or more example implementations, the evaluation set of the obtained remittance data is in the form of a data table and each row of data contains a fixed set of factors (“parameters”) describing each individual service that has been adjudicated by a payer (or insurer). Parameters include, but are not limited to, facility, facility location, facility classification, rendering provider, rendering provider credentials, service, service type, primary payer, secondary payer, subscriber, subscriber plan, patient, patient demographics, to name a few.

Continuing with reference to FIG. 1, at step s104, the computing device(s) 504 and/or 502 determines one or more subset of factors for evaluating the evaluation set of the obtained remittance data. In one or more example implementations, the computing device(s) 504 and/or 502 executes an unsupervised machine learning algorithm to stochastically determine the one or more factor sets (or “predicates”) that result in the largest observable clusters of the remittance data being evaluated.

Once one or more factor sets are determined, process 100 proceeds to step s106, where the computing device(s) 504 and/or 502 evaluates the one or more factor sets determined at step s104 on their impact on the remittance data being evaluated. According to one or more example implementations and with reference to Tables 1-3, the computing device(s) 504 and/or 502 evaluates the one or more factor sets for matching rows in the remittance data as the impact on the remittance data.

Next, at step s108, the computing device(s) 504 and/or 502 saves the results (or matched rows in the remittance data) from step s106 to a data file and removes the impacted (or matched) rows from the evaluation set of the remittance data. Process 100 then returns to step s104 and repeats steps s104 to s108 for the evaluation set of the remittance data until the evaluation set is empty.

Once the evaluation set is emptied, process 100 proceeds to steps s110, where the computing device(s) 504 and/or 502 assesses the most impactful factor sets recorded in the data file and reports the results in the data file to a user. In one or more example implementations, a graphical user interface (GUI) presentation is displayed at the computing device(s) 504 and/or 502 showing one or more factor sets containing the highest number(s) of matched rows in the obtained remittance data. In certain embodiments, the computing device(s) 504 and/or 502 can also display additional information corresponding to the claims (or remittances) that are matched to the one or more most impactful factor sets for user review and evaluation.

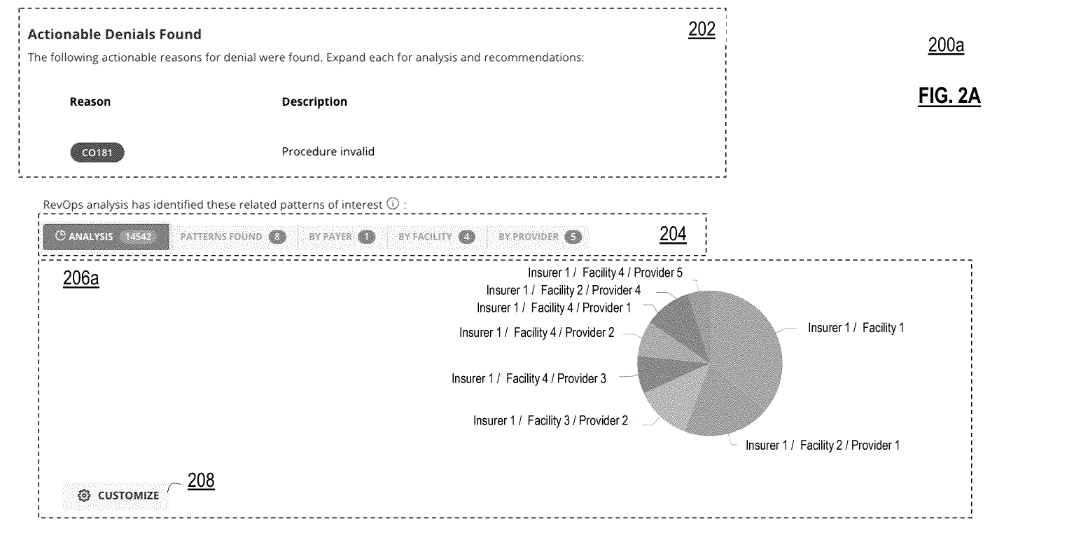

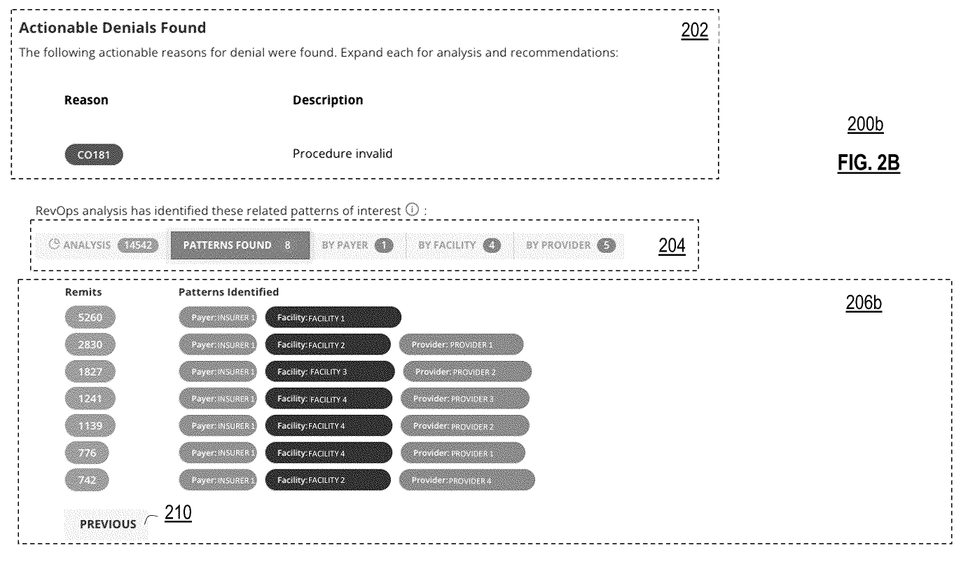

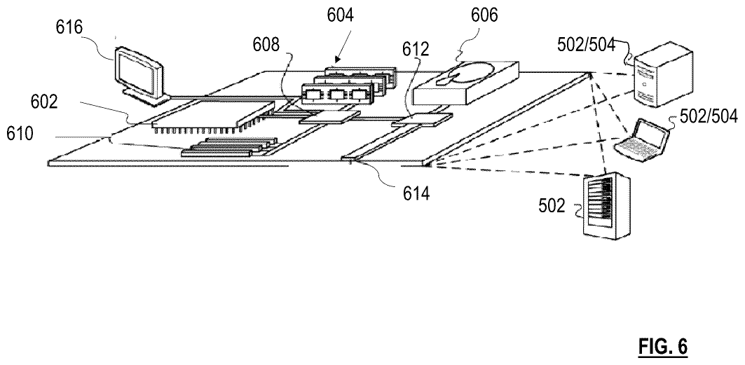

FIGS. 2A and 2B are graphical illustrations depicting GUI displays 200a and 200b, respectively, according to one or more example implementations of the present disclosure. GUI displays 200a and 200b can be rendered for display on a computing device (e.g., 502 and/or 504 in FIG. 5, or 616 in FIG. 6).

As illustrated in FIGS. 2A and 2B, GUI displays 200a and 200b comprise an actionable denial display portion 202, which displays one or more actionable denials and/or claim adjustments that are found in the obtained remittance data in process 100. In the example illustrated in FIGS. 2A and 2B, display portion 202 includes one “CO181” actionable denial that corresponds to a “Procedure invalid” determination in one or more of the matched rows (e.g., denied or adjusted claims) in the remittance data that is obtained and evaluated in process 100.

Example GUI displays 200a and 200b can further comprise a navigation portion 204 that includes multiple user-selectable navigation display portions, which can display different information corresponding to the evaluation results of process 100. In the example illustrated in FIGS. 2A and 2B, navigation portion 204 includes user-selectable tabs for “Analysis,” “Patterns Found,” “By Payer,” “By Facility,” and “By Provider.” As illustrated in FIGS. 2A and 2B, each of the user-selectable tabs include a numeral indicator of a number of items that is included in the information displayed in correspondence with selecting the respective tab-namely, 14542 records under the “Analysis” tab, eight (8) patterns under “Patterns Found,” one (1) payer (or insurer) under “By Payer,” four (4) facilities under “By Facility,” and five (5) providers under “By Provider.” In other words, FIGS. 2A and 2B illustrate an example outcome of process 100 that includes 14542 evaluated remittance records from which eight (8) patterns are found, and the records correspond to one (1) payer (or insurer), four (4) different facilities, and five (5) different providers.

A selection by a user of one of the tabs in navigation portion 204 can highlight the selected tab and change the information displayed in an information display portion 206a (FIG. 2A) and 206b (FIG. 2B).

According to one or more example implementations, a user selection of the “Analysis” tab in navigation portion 204 results in a display of an overview of the respective proportions of evaluated records that meet the respective determined factor patterns. FIG. 2A illustrates an information display portion 206a upon a user selecting the “Analysis” tab in navigation portion 204. As shown in FIG. 2A, the “Analysis” tab in navigation portion 204 is highlighted and information display portion 206a includes a pie chart of the relative proportions of eight (8) combinations of factors, which comprise respective factor patterns (or sets) in a descending order of significance as follows:
a. Insurer 1/Facility 1;
b. Insurer 1/Facility 2/Provider 1;
c. Insurer 1/Facility 3/Provider 2;
d. Insurer 1/Facility 4/Provider 3;
e. Insurer 1/Facility 4/Provider 2;
f. Insurer 1/Facility 4/Provider 1;
g. Insurer 1/Facility 2/Provider 4; and
h. Insurer 1/Facility 4/Provider 5.

Thus, according to one or more example implementations, a computing device(s) 504 and/or 502 executing process 100 determines, at step s104, the above-listed factor patterns and displays (e.g., on 616 in FIG. 6) the pie chart in information display portion 206a showing the proportions of impacted (or matched) records corresponding to each of the factor patterns, which, for example, the computing device(s) 504 and/or 502 evaluates at step s106 and saves to a data file at step s108 of process 100. As further shown in FIG. 2A, information display portion 206a includes a “Customize” button 208, which provides a user with customization options for displaying the information, for example, by changing from a pie chart to a bar chart, line graph, or the like.

FIG. 2B illustrates an example information display portion 206b upon a user selecting the “Patterns Found” tab in navigation portion 204. As shown in FIG. 2B, the “Patterns Found” tab in navigation portion 204 is highlighted and information display portion 206b includes a table listing the respective numbers of records (or instances, “remits”) that correspond to each of the above-listed factor patterns a-g.

Table 4, below, reproduces the information conveyed in information display portion 206b.

TABLE 4

| Remits | Pattern |
|---|---|
| 5260 | Insurer 1/Facility 1 |
| 2830 | Insurer 1/Facility 2/Provider 1 |
| 1827 | Insurer 1/Facility 3/Provider 2 |
| 1241 | Insurer 1/Facility 4/Provider 3 |
| 1139 | Insurer 1/Facility 4/Provider 2 |
| 776 | Insurer 1/Facility 4/Provider 1 |
| 742 | Insurer 1/Facility 2/Provider 4 |

Each row of Table 4 represents a factor set (“Pattern”) with a number of records (“Remits”) that are described by the respective factor set. As shown in Table 4 and FIG. 2B, Insurer 1/Facility 1 is a set of factors that describe the highest number (5260) of records. As further shown in FIG. 2B, information display portion 206b includes a page navigation button (“Previous”) 210, which provides for navigating between multiple pages—for example, when one or more factor patterns such as pattern h above cannot fit in the information display portion 206b.

As one of ordinary skill in the art will appreciate, navigations to “By Payer,” “By Facility,” and “By provider” in the navigation portion 204 would result in information display portions that show the 14542 records displayed by these respective factors (not shown).

Advantageously, the present disclosure provides easily accessible information related to voluminous remittance records based on identified relevant factor patterns that can be used to identify, process, and address actionable denials found in the remittance records—for example, “CO181” for “Procedure invalid” shown in display portion 202.

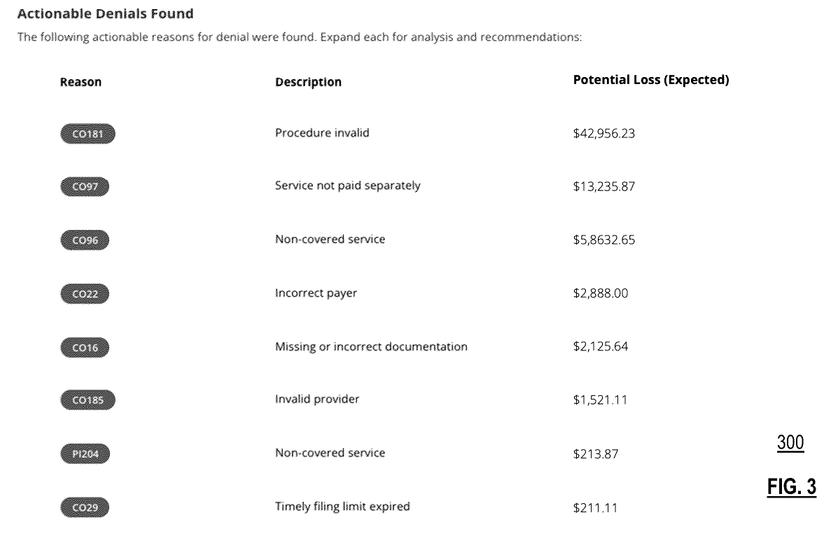

FIG. 3 is a graphical illustration depicting a GUI display 300 according to one or more example implementations of the present disclosure. In embodiments, GUI display 300 can be rendered for display on a computing device (e.g., 502 and/or 504 in FIG. 5, or 616 in FIG. 6). Table 5, below, reproduces the information conveyed in GUI display 300.

TABLE 5

| Reason | | Potential |
|---|---|---|
| (code) | Description | Loss (Expected) |
| CO181 | Procedure Invalid | $42,956,23 |
| CO97 | Service not paid separately | $13,325.87 |
| CO96 | Non-covered service | $5,832.65 |
| CO22 | Incorrect Payer | $2,888.00 |
| CO16 | Missing or incorrect documentation | $2,125.64 |
| CO185 | Invalid Provider | $1,521.11 |
| PI204 | Non-covered service | $213.87 |
| CO29 | Timely filing limit expired | $211.11 |

One of ordinary skill in the art will appreciate that the information conveyed in GUI display 300 and in Table 5 represents non-exhaustive examples of actionable denials and/or claim adjustments associated with the records shown in GUI displays 200a and 200b. Thus, advantageously, the present disclosure includes further identifying patterns among the records shown in GUI displays 200a and 200b and the actionable denials shown in GUI display 300 to, thereby, identify, process, and/or address one or more actionable denials (e.g., from Table 5) that are applicable to one or more respective factor patterns with the highest number of instances (e.g., from Table 4) among the remittance records. As further illustrated in FIG. 3, the information conveyed in GUI display 300 provides for calculating an expected value for the remittance document processing based on estimated potential losses from denials that are actionable and, therefore, recoverable from the processing. In certain embodiments, different permutations of parameters of the processed remittance documents, such as providers, modifiers, payers, diagnoses, facilities, to name a few, can be used to determine potential losses associated with actionable denials.

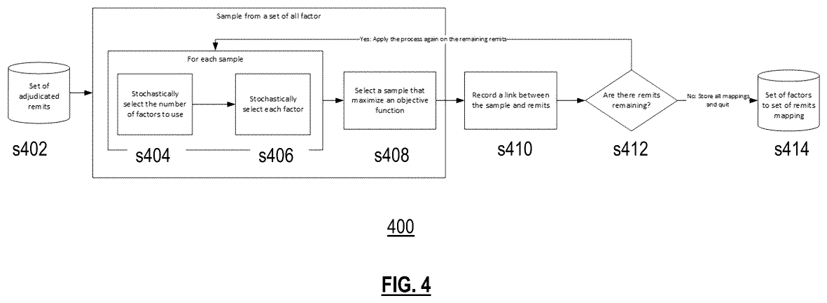

FIG. 4 is a flow diagram illustrating an example process 400 according to one or more example implementations of the present disclosure. In embodiments, process 400 can be executed at one or more computing devices 504 and/or 502 via one or more application programs.

As illustrated in FIG. 4, process 400 begins with step s402 where the computing device(s) 504 and/or 502 obtains a data set of remittance records (e.g., from database(s) 503 in FIG. 5) for processing. According to one or more example implementations, the obtained records are organized around a fixed time window, for example, a previous 12-month period. Each record contains a finite set of categorical values for a corresponding set of factors. Examples of the factors and associated categorical values include but are not limited to patient diagnoses, service(s) rendered, date(s) of service, and service provider(s), to name a few. According to one or more example implementations, the data records correspond to services for which claims have been adjusted and/or denied. In certain embodiments, the remittance records obtained in step s402 correspond in nature to the data obtained in step s102 of process 100.

Next, at step s404, the computing device(s) 504 and/or 502 selects a number of factors to filter the obtained remittance record data. According to one or more example implementations, the computing device(s) 504 and/or 502 uses a stochastic process to determine a number of factors to be included in a factor set. For each additional factor selected, the number of records that the new set of factors describes is either equal or less than a previous, smaller set of factors before the additional factor is selected. However, the benefit of choosing one more factor can outweigh the reduction in the number of records due to the fact that the larger factor set is more specific and, therefore, potentially more insightful. Thus, according to one or more example implementations, the computing device(s) 504 and/or 502 generates one or more factor set sizes at step s404 using the stochastic process based on a predetermined distribution of factor set sizes. In embodiments, the predetermined distribution can be manually defined via user input or learned from data, such as using a machine learning algorithm or the like. According to one or more example implementations, the predetermined distribution can be a truncated normal distribution centered on a preferred number of factors. The standard deviation can be used to specify a degree to penalize set sizes (e.g., a probability difference), including differences from a preferred size. Both the preferred number of factors and the probability differences can be learned from user interactions, such as using a machine learning algorithm or the like, or manually set to preferred values.

Concurrent with or subsequent to step s404, the computing device(s) 504 and/or 502 executes step s406 recursively, or iteratively, to analyze the obtained or remaining remittance records in terms of an incrementally selected factor according to the factor set size(s) determined at step s404. In one or more example implementations, the computing device(s) 504 and/or 502 uses a stochastic process to incrementally select an additional factor to filter an additional subset of the remittance records included in the obtained or remaining data in order to assign a weight to each possible factor. The computing device(s) 504 and/or 502 transforms the assigned weights into a probability distribution and draws each selected factor from the probability distribution. In certain embodiments, the computing device(s) 504 and/or 502 can assign the weights and distribution to respective categories of the factors. The computing device(s) 504 and/or 502 then adds the selected factor to a set of factors. According to one or more example implementations, the probability is a discrete distribution that gives more probability to factors that have less cardinality than those that due. The idea being that a factor with fewer possible categorical values is more likely to uncover a significant insight. According to one or more implementations, the probability distribution is a discrete distribution based on the respective numbers of records that are described by each factor. For example, the computing device(s) 504 and/or 502 assigns factors that have less cardinality with higher probabilities in the discrete distribution to account for a factor with fewer possible categorical values being more likely to uncover a significant insight. In another example, the probability distribution is a uniform distribution. In embodiments, the probability distribution can be manually defined via user input or learned from data, such as using a machine learning algorithm or the like.

Next, at step s408, when a set of factors selected at step s406 reaches a size selected at step s404, the computing device(s) 504 and/or 502 gathers all of the records described by the factor set and ranks the factor set against any other factor sets that have been gathered on one or more previous recursions, or iterations, of steps s404 and s406 based on an objective utility function (ƒ (x)) that balances specificity with generality of samples and the number of records those samples describe. Equation (1) provides one example objective function ƒ (x) that can be used to evaluate each factor in a factor set:

$$f ( x ) = \frac{\# of records containing value x for a factor}{total \# of records} \qquad ( 1 )$$

Equation (2) provides another example objective function g (x,y) that augments objective function ƒ(x) by taking into account a confidence value for each factor value x in a factor set with size y:

$$g ( x , y ) = f ( x ) * w * yN ( z , {σ}^{2} ) \qquad ( 2 )$$

where w is a weight for factor value x, and
σ is the standard deviation of a normal distribution N ( ) centered on preferred factor size z.

In certain embodiments, weight w, preferred factor size z, and normal distribution N ( ) can be set manually or learned from data, such as using a machine learning algorithm or the like.

According to one or more example implementations, the computing device(s) 504 and/or 502 executes steps s404, s406, and s408 recursively (or iteratively) until all records obtained at step s402 have been described in at least one factor set. In certain embodiments, the recursion (or iteration) can be based on all factors having been selected in at least one factor set, a predetermined number of factor sets (e.g., 2 to 8, or 5) have been completed, a predetermined distribution of factor set sizes has been completed, a predetermined portion of the records (e.g., 90%) obtained at step s402 has been described in at least one factor set, a predetermined number of factor sets (e.g., 5 to 7 or 6) that have met a threshold portion of records described (e.g., 5% to 10% or 7% of total records), to name a few.

Based on the ranking, the computing device(s) 504 and/or 502 selects a final factor set based on a maximum utility or a probability distribution of utility values among the ranked factor sets. In embodiments, the probability distribution can be manually defined via user input or learned from data, such as using a machine learning algorithm or the like. According to one or more example implementations, the probability distribution of utility values is a discrete distribution where the weight of choosing a sample is based on how many times it was chosen modulated by the utility of that sample . . .

Once a factor set is selected, process 400 proceeds to step s410, where the computing device(s) 504 and/or 502 records the selected factor set to a data file(s) and/or a database(s) (e.g., 503 in FIG. 5) along with a mapping to at least a subset of the records the factor set describes. The computing device(s) 504 and/or 502 removes the records described by the selected factor set from subsequent factor set selections and determines, at step s412, whether any records remain after the removal. If there are records that remain for processing after the removal (“Yes”), then process 400 returns to step s404 and the computing device(s) 504 and/or 502 repeats the factor set selection procedure of steps s404, s406, s408, and s410 on the remaining records. Thus, the computing device(s) 504 and/or 502 executes steps s404, s406, s408, and s410 recursively (or iteratively) until all records obtained at step s402 are described in at least one factor set.

Finally, if no records remain after the computing device(s) 504 and/or 502 executes a records removal based on a selected factor set at step s410 (“No”), process 400 ends with step s414, where the computing device(s) 504 and/or 502 outputs a collection of factor sets along with a mapping between each factor set in the collection to the remittance records that they describe. According to one or more example implementations, the output of step s414 corresponds to the information conveyed in example GUI displays 200a and 200b (e.g., Table 4), where the displayed “patterns” correspond to the factor sets and the displayed “remits” correspond to the number of remittance records that the respective factor sets describe. In certain embodiments, the output can further include correlations to one or more actionable adjudication decisions, such as those represented in example GUI display 300 and Table 5.

Referring to FIG. 5, a diagram is provided that shows an example hardware arrangement that operates for providing the systems and methods disclosed herein and designated generally as system 500. System 500 can include one or more information processors 502 that are at least communicatively coupled to one or more user computing devices 504 across communication network 506. Information processors 502 and user computing devices 504 can include, for example, mobile computing devices such as tablet computing devices, smartphones, personal digital assistants or the like, as well as laptop computers and/or desktop computers, server computers and mainframe computers. Further, one computing device may be configured as an information processor 502 and a user computing device 504, depending upon operations being executed at a particular time.

With continued reference to FIG. 5, information processor 502 can be configured to access one or more databases 503 for the present disclosure, including source code repositories and other information. However, it is contemplated that information processor 502 can access any required databases via communication network 506 or any other communication network to which information processor 502 has access. Information processor 502 can communicate with devices comprising databases using any known communication method, including a direct serial, parallel, universal serial bus (“USB”) interface, or via a local or wide area network.

User computing devices 504 can communicate with information processors 502 using data connections 508, which are respectively coupled to communication network 506. Communication network 506 can be any communication network, but typically is or includes the Internet or other computer network. Data connections 508 can be any known arrangement for accessing communication network 506, such as the public internet, private Internet (e.g. VPN), dedicated Internet connection, or dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 504 preferably have the ability to send and receive data across communication network 506, and are equipped with web browsers, software disclosures, or other means, to provide received data on display devices incorporated therewith. By way of example, user computing device 504 may be personal computers such as Intel Pentium-class and Intel Core-class computers or Apple Macintosh computers, tablets, smartphones, but are not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 506, and that wireless communication can be provided between wireless devices and information processors 502.

System 500 preferably includes software that provides functionality described in greater detail herein, and preferably resides on one or more information processors 502 and/or user computing devices 504. One of the functions performed by information processor 502 is that of operating as a web server and/or a web site host. Information processors 502 typically communicate with communication network 506 across a permanent i.e., un-switched data connection 508. Permanent connectivity ensures that access to information processors 502 is always available.

FIG. 6 shows an example information processor 502 that can be used to implement the techniques described herein. Information processor 502 is intended to represent various forms of digital computers, such as laptops, desktops, workstations, personal digital assistants, servers, blade servers, mainframes, and other appropriate computers. The components shown in FIG. 6, including connections and relationships, and their functions, are meant to be exemplary only, and are not meant to limit implementations of the inventions described and/or claimed in this document.

The information processor 502 can include a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and can be mounted on a common motherboard or in other manners as appropriate. The processor 602 can process instructions for execution within the information processor 102, including instructions stored in the memory 604 or on the storage device 606 to display graphical information for a GUI on an external input/output device, such as a display 616 coupled to the high-speed interface 608. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 604 stores information within the information processor 102. In some implementations, the memory 604 is a volatile memory unit or units. In some implementations, the memory 604 is a non-volatile memory unit or units. The memory 604 can also be another form of computer-readable medium, such as a magnetic or optical disk.

The storage device 606 is capable of providing mass storage for the information processor 102. In some implementations, the storage device 606 can be or contain a computer-readable medium, e.g., a computer-readable storage medium such as a floppy disk device, a hard disk device, an optical disk device, or a tape device, a flash memory or other similar solid-state memory device, or an array of devices, including devices in a storage area network or other configurations. A computer program product can also be tangibly embodied in an information carrier. The computer program product can also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 can be configured to manage bandwidth-intensive operations, while the low-speed interface 612 can be configured to manage lower bandwidth-intensive operations. Of course, one of ordinary skill in the art will recognize that such allocation of functions is exemplary only. In some implementations, the high-speed interface 608 is coupled to the memory 604, the display 616 (e.g., through a graphics processor or accelerator), and to the high-speed expansion ports 610, which can accept various expansion cards (not shown). In an implementation, the low-speed interface 612 is coupled to the storage device 606 and the low-speed expansion port 614. The low-speed expansion port 614, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

As noted herein, information processor 502 can be implemented in a number of different forms, such as a standard server, or multiple times in a group of such servers. It can also be implemented as part of a rack server system. In addition, information processor 502 and user computing device 504 can be implemented in a personal computer, such as a laptop computer. Alternatively, components from the computing device 502/504 can be combined with other components in a mobile device (not shown), such as a mobile computing device.

The following is a non-limiting example for illustrating an execution of process 400 of the present disclosure.

Table 6, below, shows a sample of six (6) remittance records for demonstrating the example.

TABLE 6

| Payer | Provider | Facility |
|---|---|---|
| PAYER 1 | PROVIDER 1 | FACILITY 2 |
| PAYER 1 | PROVIDER 2 | FACILITY 1 |
| PAYER 2 | PROVIDER 1 | FACILITY 1 |
| PAYER 2 | PROVIDER 1 | FACILITY 1 |
| PAYER 2 | PROVIDER 3 | FACILITY 1 |
| PAYER 2 | PROVIDER 2 | FACILITY 3 |

Maximizing an objective function (ƒ (x)) directly (or sampling from it) from the records would otherwise require generating full record data samples and would, therefore, be computationally demanding. Thus, as described above, a computing device(s) 504 and/or 502 executing a process(es) conforming to the present disclosure (e.g., 100 or 400) selects a sample factor set that is correlated to positive values of an objective function from respective distributions for each factor. Based on this technique, the computing device(s) 504 and/or 502 can generate a subset of samples with an understanding that they would be proximate an optimal solution without the need to process all factor combinations using a known brute force process or the like.

In correspondence with step s404 (and/or step s104), the computing device(s) 504 and/or 502 generates a distribution of factor set sizes. In this example corresponding to Table 6, the computing device(s) 504 and/or 502 is set to more likely select two (2) columns (e.g., 75% probability), and set to least likely select one (1) column (e.g., 25% probability). Accordingly, the computing device(s) 504 and/or 502 determines the factor set size based on a stochastic process on the generated distribution. In this example, the computing device(s) 504 and/or 502 determines the factor set size to be two (2) columns.

Corresponding to step s406 of process 400 (and/or step s106 of process 100), the computing device(s) 504 and/or 502 selects one of the columns in Table 6 based on a stochastic process. In this example, “Provider” is selected.

Table 7, below, shows the factors that describe the records of Table 6 under the “Provider” column (or category).

TABLE 7

| | Frequency |
|---|---|
| Provider | Count |
| PROVIDER 1 | 3 |
| PROVIDER 2 | 2 |
| PROVIDER 3 | 1 |

As can be seen from the above, if the factor Provider=Provider 3 is selected, the factor set would only describe a single record, which would in turn dictate that the next factor selected would either equal Payer=Payer 2 or Facility=Facility 1. Selecting Provider=Provider 2 or Provider=Provider 3 would provide more options in the next steps.

Given this information, it is more likely that the optimal factor set has Provider=Provider 1 than Provider=Provider 3. Accordingly, the computing device(s) 504 and/or 502 generates a discrete distribution, where the probability for selecting the respective factors are as follows:

$$a . p ( Provider = Provider 1 ) = 3 / 6 = 50 \% ;$$

$$b . p ( Provider = Provider 2 ) = 2 / 6 = 33 \% ; and$$

$$c . p ( Provider = Provider 3 ) = 1 / 6 = 17 \% .$$

In this example, the computing device(s) 504 and/or 502 selects the factor Provider=Provider 2 based on a stochastic process. Accordingly, the computing device(s) 504 and/or 502 filters the information represented in Table 6 to only the rows corresponding to Provider=Provider 2. With the selected Provider=Provider 2, the computing device(s) 504 and/or 502 can filter the Provider category for factor evaluation, as shown in Table 8 below.

TABLE 8

| Payer | Facility |
|---|---|
| PAYER 1 | FACILITY 1 |
| PAYER 2 | FACILITY 3 |

Corresponding to step s406 of process 400 (and/or step s106 of process 100), the computing device(s) 504 and/or 502 selects another column, Payer, based on a stochastic process.

The probabilities of selecting the factors in this column are as follows:

$$a . p ( Payer = Payer 1 ) = 1 / 2 = 50 \% ; and$$

$$b . p ( Payer = Payer 2 ) = 1 / 2 = 50 \% .$$

Based on a stochastic process, the computing device(s) 504 and/or 502 selects the factor Payer=Payer 2 in this example.

With the factor set reaching the selected size, the computing device(s) 504 and/or 502 returns the factor set {Provider=Provider 2, Payer=Payer 2}.

In this example, the computing device(s) 504 and/or 502 selects additional factor sets based on a recursive process to yield the following sets with the corresponding number of row matches:
a. {Provider=Provider 2, Payer=Payer 2}: 1 row;
b. {Provider=Provider 1}: 3 rows;
c. {Provider=Provider 1, Payer=Payer 2}: 2 rows;
d. {Facility=Facility 1}: 4 rows; and
   {Facility=Facility 1, Payer=Payer 2}: 3 rows.

Next, in correspondence with step s408 of process 400 (and/or step s106 of process 100), the computing device(s) 504 and/or 502 executes an objective function for each of the selected factor sets, which yields the following utility scores:
a. obj ({Provider=Provider 2, Payer=Payer 2}: 1 row)=0.5;
b. obj ({Provider=Provider 1}: 3 rows)=2.5;
c. obj ({Provider=Provider 1, Payer=Payer 2}: 2 rows)=2.5;
d. obj ({Facility=Facility 1}: 4 rows)=3.0; and
e. obj ({Facility=Facility 1, Payer=Payer 2}: 3 rows)=3.1.

As reflected by a score of 3.1 for objective function e, a score of 3.0 for objection function d, and a score of 2.5 for the objective function b, the computing device(s) 504 and/or 502 executing a process(es) conforming to the present disclosure weighs the length of a factor rule (or set) slightly more than the number of records described by the factor rule (or set). Based on the utility scores, {Facility=Facility 1, Payer=Payer 2} is selected.

In correspondence with steps s410 or process 400 (and/or step s108 of process 100), the computing device(s) 504 and/or 502 saves the records described by the selected factor set {Facility=Facility 1, Payer=Payer 2} to a data file(s) and/or database(s). Corresponding to step s412 of process 400 (and/or step s108 of process 100), the computing device(s) 504 and/or 502 removes these records from Table 6 for a next recursion of factor set selection based on the fact that records still remain after the removal, as shown in Table 9 below.

TABLE 9

| Payer | Provider | Facility |
|---|---|---|
| PAYER 1 | PROVIDER 1 | FACILITY 2 |
| PAYER 1 | PROVIDER 2 | FACILITY 1 |
| [symbol] | [symbol] | [symbol] |
| [symbol] | [symbol] | [symbol] |
| [symbol] | [symbol] | [symbol] |
| PAYER 2 | PROVIDER 2 | FACILITY 3 |

In correspondence with step s414 of process 400 (and/or step s110 of process 100), the computing device(s) 504 and/or 502 ends the evaluation process and outputs results upon removing all of the remaining rows in Table 9 through the factor set selection steps.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). To facilitate understanding, like reference numerals have been used, where possible, to designate like elements common to the figures. In certain instances, a letter suffix following a dash ( . . . -b) denotes a specific example of an element marked by a particular reference numeral (e.g., 210-b). Description of elements with references to the base reference numerals (e.g., 210) also refer to all specific examples with such letter suffixes (e.g., 210-b), and vice versa.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof, and are meant to encompass the items listed thereafter and equivalents thereof as well as additional items.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting.

While the disclosure has described several example implementations, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for carrying out this disclosure, but that the disclosure will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope encompassed by the present disclosure, which is defined by the set of recitations in the following claims and by structures and functions or steps which are equivalent to these recitations.

What is claimed is:

1. An apparatus for processing a plurality of records associated with respective adjudication decisions, comprising:
a computer network interface to a network;
a processor operatively connected to the computer network interface; and
a memory storage operatively connected to the processor and having stored thereon machine-readable instructions that cause the processor, when executed, to:
obtain, via the computer network interface, a plurality of records associated with respective one or more adjudication decisions;
proceed, starting with a plurality of factors comprised in the obtained plurality of records and in an iterative or recursive manner, to:
determine a number of factors for evaluating the obtained plurality of records,
select the determined number factors from a plurality of factors comprised in the obtained plurality of records,
identify a subset of records described by the selected factors,
record the identified subset of records in association with the selected factors as a factor set to a data storage, and
remove the subset of records from the obtained plurality of records for a next iteration until the obtained plurality of records have been all removed; and
output a plurality of factor sets and associated subsets of records from the data storage for displaying the plurality of factor sets and associated subsets of records in correspondence with one or more adjudication decisions comprised in the associated subsets of records.

2. The apparatus of claim 1, wherein the number of factors is determined according to a probability distribution.

3. The apparatus of claim 1, wherein the determined number of factors are each selected according to a probability distribution generated based on respective numbers of records described by respective ones of the plurality of factors.

4. The apparatus of claim 1, wherein determining of the number of factors, the selecting of the determined number factors, and identifying of the subset of records are performed in an iterative or recursive manner to generate a plurality of factor sets and associated subsets of records, and
recording of the subset of records further comprises selecting from the plurality of factor sets and associated subsets of records for the recording to the data storage.

5. The apparatus of claim 4, wherein selecting from the plurality of factor sets and associated subsets of records further comprises comparing utility scores for each of the plurality of factor sets.

6. The apparatus of claim 5, wherein the utility scores are generated based on an objective function executed for each of the plurality of factor sets and associated subsets of records.

7. The apparatus of claim 6, wherein the objective function weighs lengths of the plurality of factor sets more than respective sizes of the associated subsets of records.

8. The apparatus of claim 1, wherein the one or more adjudication decisions are selected from the group consisting of: CO181 procedure invalid, CO97 service not paid separately, CO96 non-covered service, CO22 incorrect payer, CO16 missing or incorrect documentation, CO185 invalid provider, PI204 non-covered service, and CO29 timely filing limit expired.

9. A method of a computer apparatus for processing a plurality of records associated with respective adjudication decisions, said method comprising:
obtaining, at the computer apparatus via a computer network interface, a plurality of records associated with respective one or more adjudication decisions;
proceeding, at the computer apparatus and starting with a plurality of factors comprised in the obtained plurality of records and in an iterative or recursive manner, to:
determine a number of factors for evaluating the obtained plurality of records,
select the determined number factors from a plurality of factors comprised in the obtained plurality of records,
identify a subset of records described by the selected factors,
record the identified subset of records in association with the selected factors as a factor set to a data storage, and
remove the subset of records from the obtained plurality of records for a next iteration until the obtained plurality of records have been all removed; and
outputting, at the computer apparatus, a plurality of factor sets and associated subsets of records from the data storage for displaying the plurality of factor sets and associated subsets of records in correspondence with one or more adjudication decisions comprised in the associated subsets of records.

10. The method of claim 9, wherein the number of factors is determined according to a probability distribution.

11. The method of claim 9, wherein the determined number of factors are each selected according to a probability distribution generated based on respective numbers of records described by respective ones of the plurality of factors.

12. The method of claim 9, wherein determining of the number of factors, selecting of the determined number factors, and identifying of the subset of records are performed in an iterative or recursive manner to generate a plurality of factor sets and associated subsets of records, and
recording of the subset of records further comprises selecting from the plurality of factor sets and associated subsets of records for the recording to the data storage.

13. The method of claim 12, wherein selecting from the plurality of factor sets and associated subsets of records further comprises comparing utility scores for each of the plurality of factor sets.

14. The method of claim 13, wherein the utility scores are generated based on an objective function executed for each of the plurality of factor sets and associated subsets of records.

15. The method of claim 14, wherein the objective function weighs lengths of the plurality of factor sets more than respective sizes of the associated subsets of records.

16. The method of claim 9, wherein the one or more adjudication decisions are selected from the group consisting of: CO181 procedure invalid, CO97 service not paid separately, CO96 non-covered service, CO22 incorrect payer, CO16 missing or incorrect documentation, CO185 invalid provider, PI204 non-covered service, and CO29 timely filing limit expired.
